(19) United States
(12) Patent Application Publication
(10) Pub. No.: US 2020/0372396 A1
(43) Pub. Date: Nov. 26, 2020

(54) OPTIMAL CONTENT IDENTIFICATION FOR LEARNING PATHS

(71) Applicant: International Business Machines Corporation, Armonk, NY (US)

(72) Inventors: JOSEPH KOZHAYA, MORRISVILLE, NC (US); SHIKHAR KWATRA, DURHAM, NC (US); PRITESH PATEL, RALEIGH, NC (US); ANANTHA S. RAO, CARY, NC (US); CRAIG COOK, RALEIGH, NC (US)

(21) Appl. No.: 16/416,854

(22) Filed: May 20, 2019

(51) Int. Cl. G06N 20/00; G06N 5/04; G06F 17/27

(52) U.S. Cl. CPC G06N 20/00; G06F 17/2785; G06N 5/048

(57) ABSTRACT

A method selects content based on a learning relevancy targeted to specific recipients. One or more processors extract semantic features, which provide meanings of concepts, from each content asset from a plurality of content assets. The processor(s) utilize a clustering algorithm to group entries in the content assets based on the semantic features in order to form hierarchical consolidated entries for the semantic features, where each hierarchical consolidated entry is associated with one of the semantic features. The processor(s) then provide a representation of each of the hierarchical consolidated entries based on a target audience criteria.

### BACKGROUND

The present invention relates to the field of artificial intelligence, and specifically to machine learning models used in artificial intelligence. Still more particularly, the present invention relates to identifying optimal content for learning models used to train artificial intelligence.

### SUMMARY

In an embodiment of the present invention, a method selects content based on a learning relevancy targeted to specific recipients. One or more processors extract semantic features, which provide meanings of concepts, from each content asset from a plurality of content assets. The processor(s) utilize a clustering algorithm to group entries in the content assets based on the semantic features in order to form hierarchical consolidated entries for the semantic features, where each hierarchical consolidated entry is associated with one of the semantic features. The processor(s) then provide a representation of each of the hierarchical consolidated entries based on a target audience criteria.

In one or more embodiments, the method(s) described herein are performed by an execution of a computer program product and/or a computer system.

### BRIEF DESCRIPTION OF THE DRAWINGS

FIG. 1 depicts an exemplary system and network in which the present invention may be implemented;

FIG. 2 illustrates a high-level overview of one or more components of the present invention;

FIG. 3 is a high-level flow chart of one or more embodiments of the present invention;

FIG. 4 depicts additional detail of one or more embodiments of the present invention;

FIG. 5 is a high-level flow chart of one or more steps performed in accordance with one or more embodiments of the present invention;

FIG. 6 depicts an exemplary deep neural network as used in one or more embodiments of the present invention;

FIG. 7 illustrates an exemplary Convolutional Neural Network (CNN) as used in one or more embodiments of the present invention;

FIG. 8 depicts additional functionality detail of the CNN illustrated in FIG. 7;

FIG. 9 illustrates an exemplary photo image being evaluated/inferred using a CNN in accordance with one or more other embodiments of the present invention;

FIG. 10 depicts a cloud computing environment according to an embodiment of the present invention; and

FIG. 11 depicts abstraction model layers of a cloud computer environment according to an embodiment of the present invention.

### DETAILED DESCRIPTION

In one or more embodiments, the present invention is a system, a method, and/or a computer program product at any possible technical detail level of integration. In one or more embodiments, the computer program product includes a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In one or more embodiments, computer readable program instructions for carrying out operations of the present invention comprise assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. In one or more embodiments, the computer readable program instructions execute entirely on the user's computer, partly on the user's computer, as a stand-alone software package, partly on the user's computer and partly on a remote computer or entirely on the remote computer or server. In the latter scenario and in one or more embodiments, the remote computer connected to the user's computer through any type of network, including a local area network (LAN) or a wide area network (WAN), or the connection is made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

In one or more embodiments, these computer readable program instructions are provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In one or more embodiments, these computer readable program instructions are also stored in a computer readable storage medium that, in one or more embodiments, direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In one or more embodiments, the computer readable program instructions are also loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams represents a module, segment, or portion of instructions, which comprises one or more executable instructions for implementing the specified logical function(s). In some alternative implementations, the functions noted in the block occur out of the order noted in the figures. For example, two blocks shown in succession are, in fact, executed substantially concurrently, or the blocks are sometimes executed in the reverse order, depending upon the functionality involved. It will also be noted that, in one or more embodiments of the present invention, each block of the block diagrams and/or flowchart illustration, and combinations of blocks in the block diagrams and/or flowchart illustration, are implemented by special purpose hardware-based systems that perform the specified functions or acts or carry out combinations of special purpose hardware and computer instructions.

In the current digital age, in which there is a high quantity of available information, it becomes difficult for information consumers to identify which assets are most useful to them. In enterprises, as products, offerings, and solutions continually change, it is useful to find the most relevant content to aid the enterprise, its customers, reviewers, etc.

As such, one or more embodiments of the present invention identify the right content assets or sub-assets to deliver a required learning objective, in order to improve the operations of a computer. That is, by employing the practical application of extracting and combining semantic features from various assets (e.g., sentences/paragraphs from text; photos from digital images) according to the needs of the end user, the information needed by the end user is delivered in a fast and useful manner.

Thus, one or more embodiments of the present invention extract semantic information from various content sources, and then identify which subset of content captures all/most of the semantic information needed by the end user.

In an embodiment of the present invention, the content in the content sources is segmented into sub-content documents, in order to obtain better granularity. That is, content is sub-divided, and each sub-division is examined for semantic information for that sub-division, thus providing additional granularity to the invention described herein.

In an embodiment of the present invention, a determination is made as to how well a certain concept is addressed by a content based on a variety of factors, such as a natural language processing (NLP) score and a user review score. This scoring enables the system to return the most relevant and most useful content. That is, a NLP evaluation of end-user feedback, and/or a feedback score directly provided by the end-user, indicates how well the extracted semantic features from the assets meet the informational needs of the end-user, thus allowing the system to constantly improve by adjusting which semantic features are provided to the end-user.

As such, one or more embodiments of the present invention delivers a dynamic and robust solution for identifying which pieces of content are most useful for delivery to a target population, in a manner that is a fast and efficient method for extracting and presenting the most relevant content to users, thereby improving the functionality of the computer system on which the invention is performed.

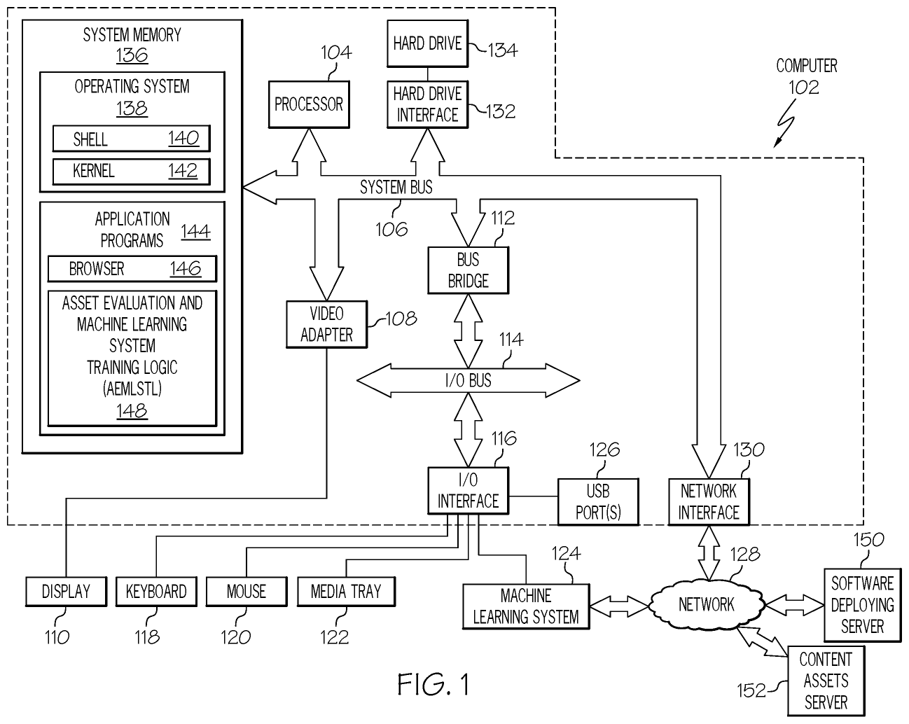

With reference now to the figures, and in particular to FIG. 1, there is depicted a block diagram of an exemplary system and network that may be utilized by and/or in the implementation of the present invention. Note that some or all of the exemplary architecture, including both depicted hardware and software, shown for and within computer 102 may be utilized by software deploying server 150 and/or machine learning system 124 and/or content assets server 152.

Exemplary computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a machine learning system 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 and/or the machine learning system 124 using a network interface 130 to a network 128. Network interface 130 is a hardware network interface, such as a network interface card (NIC), etc. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

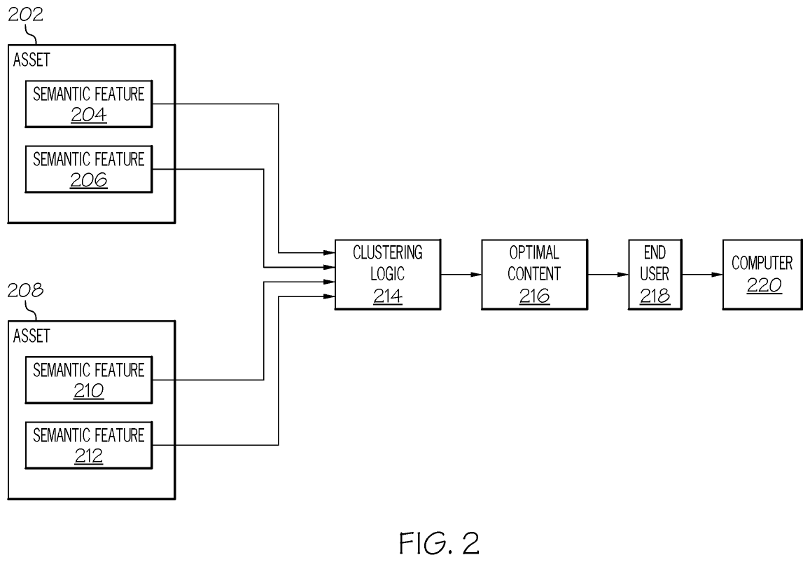

Application programs 144 in computer 102's system memory (as well as software deploying server 150's system memory) also include an Asset Evaluation and Machine Learning System Training Logic (AEMLSTL) 148. AEMLSTL 148 includes code for implementing the processes described below, including those described in FIGS. 2-9. In one embodiment, computer 102 is able to download AEMLSTL 148 from software deploying server 150, including in an on-demand basis, wherein the code in AEMLSTL 148 is not downloaded until needed for execution. Note further that, in one embodiment of the present invention, software deploying server 150 performs all of the functions associated with the present invention (including execution of AEMLSTL 148), thus freeing computer 102 from having to use its own internal computing resources to execute AEMLSTL 148.

Also connected to (or alternatively, as part of) computer 102 is a content assets server 152, which stores and/or provides the content assets described herein.

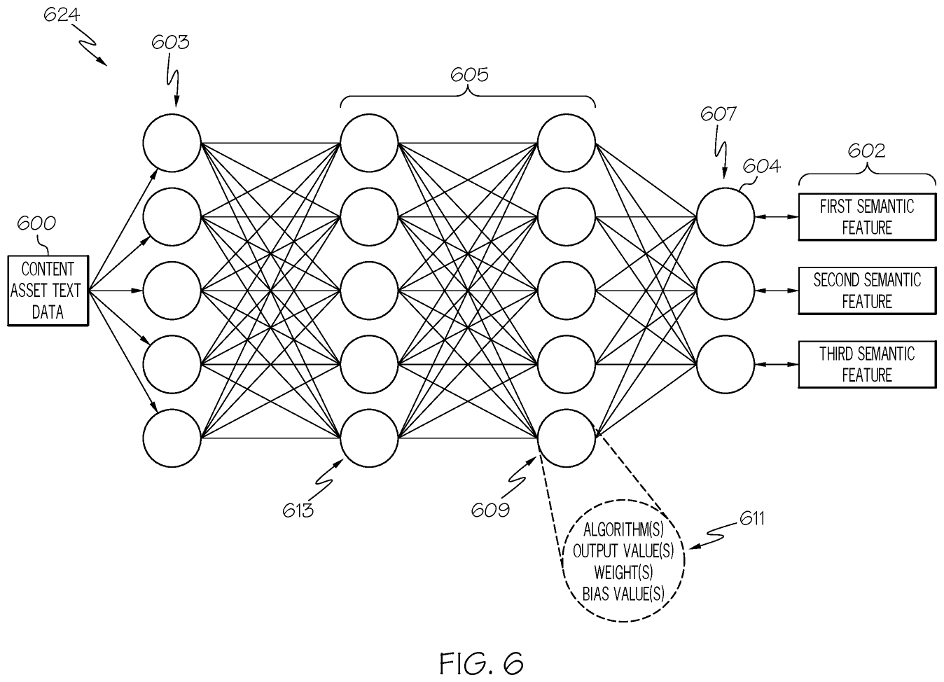

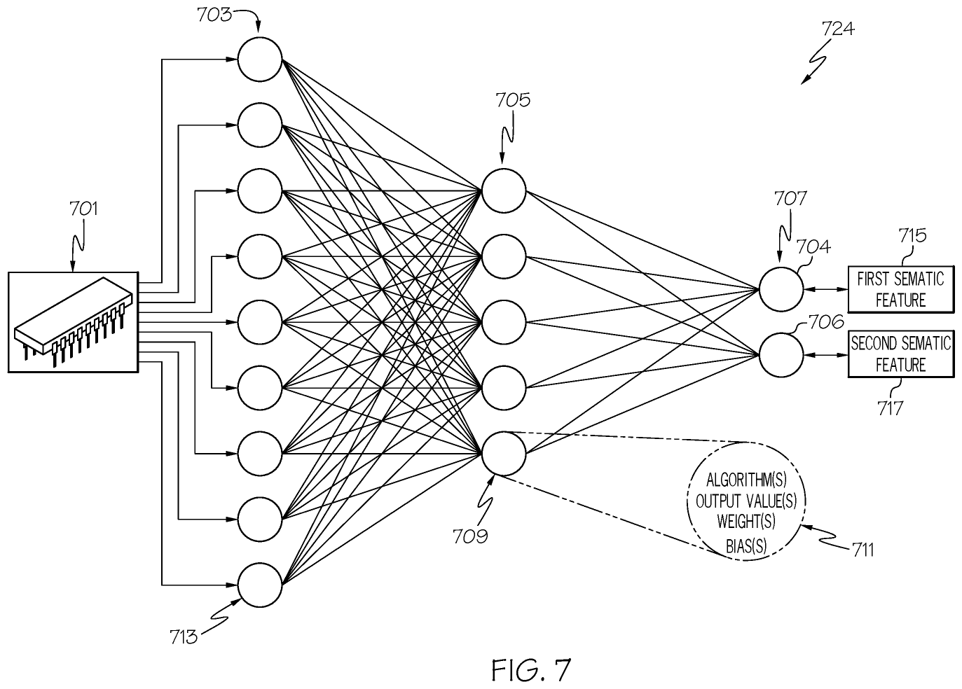

Also connected to (or alternatively, as part of) computer 102 is a machine learning system 124. In exemplary embodiments of the present invention, machine learning system 124 is a deep neural network (see FIG. 6), a convolutional neural network (see FIGS. 7-9), or another type of artificial intelligence.

Note that the hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

With reference now to FIG. 2, assume that optimal content 216 is desired for an end-user 218. This optimal content 216 is content that provides information that the end-user 218 has expressed an interest in learning, needs to perform his/her job, needs to evaluate a process, needs to perform an operation, etc. This information is extracted as semantic features from assets, which include various types of content such as documents, web pages, wikis, videos, etc.

For example, assume that end user 218 has expressed a need for information on how to upgrade the random access memory (RAM) on his/her computer. In various embodiments of the present invention, asset 202 and asset 208 are both text documents; or alternatively that asset 202 and asset 208 are both video files; or alternatively that asset 202 is a text file and asset 208 is a video file. For purposes of illustration, assume that asset 202 and asset 208 are both text documents.

Within asset 202 are various text passages, which describe various semantic features (i.e., passages that have certain meanings, teachings, etc. about particular topics). For example, semantic feature 204 could describe a model number of an upgrade RAM chip for a particular computer; semantic feature 206 could describe a keyboard on that particular computer; semantic feature 210 (a text passage within asset 208) could describe a location and appearance of a memory chip slot within that particular computer; and semantic feature 212 could describe a color of that particular computer. As such, the end user 218 needs semantic feature 204 (description of the upgrade RAM chip) and semantic feature 210 (description of the location and appearance of the memory chip slot) in order to know how to upgrade the RAM on his/her computer, but does not need the semantic feature 206 (describing the keyboard) or the semantic feature 212 (describing the color of the computer).

In order to identify semantic feature 204 and semantic feature 210 as relevant to upgrading the computer RAM, a clustering logic 214 is utilized in an embodiment of the present invention.

Clustering logic 214 generates data vectors that describe features of the semantic features found in asset 202 and asset 208. These data vectors include attributes (e.g., a model number of RAM chip, a type of keyboard on a computer, a description of a memory slot, a color of a computer) that have values associated with certain information.

For example, assume that a first data vector (for semantic feature 204) includes the tuple “1, 2, 3”, in which the first value “1” indicates a particular computer model (“Computer X”), the second value “2” indicates a particular RAM memory chip, and the third value “3” indicates a release date of that particular RAM memory chip.

Assume further that a second data vector (for semantic feature 206) includes the tuple “1, 4, 5”, in which the first value “1” indicates a particular computer model (“Computer X”), the second value “4” indicates a particular keyboard, and the third value “5” indicates a price of the keyboard.

Assume further that a third data vector (for semantic feature 210) includes the tuple “1, 2, 6”, in which the first value “1” indicates a particular computer model (“Computer X”), the second value “2” indicates the particular RAM memory chip, and the third value “6” indicates a description of a memory slot used by that particular RAM memory chip.

Assume further that a fourth data vector (for semantic feature 212) includes the tuple “1, 7, 8, in which the first value “1” indicates a particular computer model (“Computer X”), the second value “7” indicates a color of Computer X, and the third value “8” indicates a price of Computer X.

When plotted and clustered, the first data vector and the third data vector will be closest together, since their tuple values more closely match than any other pairing/combination of the other data vectors. Since the first data vector and the third data vector both include values related to Computer X and the particular RAM memory chip, they are clustered together closely by clustering logic 214, which combines their information into an optimal content 216, which is sent to the end user 218 to aid the end user 218 in installing the new RAM memory chip in his/her computer.

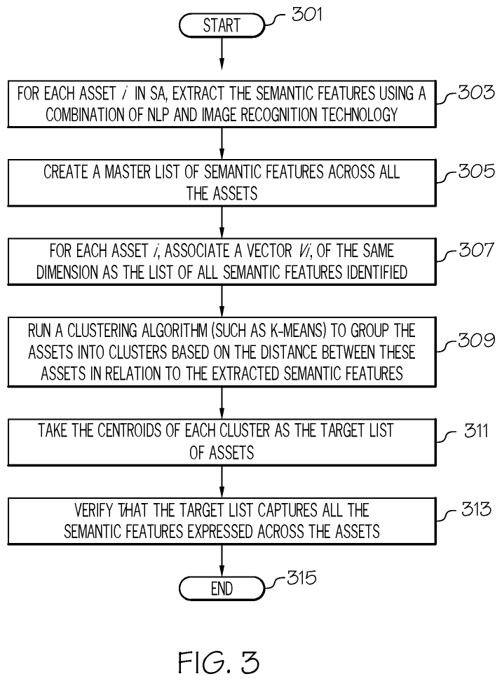

With reference now to FIG. 3, a more detailed description of the process described in FIG. 2 is presented.

The flow-chart shown in FIG. 3 assumes that a set SA of N assets is very large (i.e., much more than hundreds of assets), rather than just the two assets 202 and 208 shown in FIG. 2.

Thus, after initiator block 301, and as depicted in block 303 in FIG. 3, for each asset i in SA, the semantic features are extracted using a combination of natural language processing (NLP—for text assets, using semantic features such as topics, entities, keywords, etc.) and image recognition technology (for image assets). That is, NLP is used to extract sematic features from text, and a combination of NLP and/or image recognition is used to extract semantic features from image assets.

In an embodiment of the present invention, each of the extracted semantic features are associated with a confidence score. This confidence score indicates how well a particular semantic feature (and/or the entire asset from which it came) captures (or represents) a particular concept.

In an embodiment of the present invention, this confidence score is generated by feedback from the end user, indicating how well the extracted semantic features met his/her needs for performing a certain task, understanding a particular concept, etc.

In another embodiment of the present invention, this confidence score is generated by the vector distances between semantic feature vectors, as produced by the clustering logic 214 shown in FIG. 2.

As shown in block 305, the system then creates a master list of semantic features across all the assets. For example, the semantic features 204, 206, 210, and 212 shown in FIG. 2 are all combined into a master list. Thus, the system runs in linear time through all assets, and checks to see if the semantic features exist in a master list. If yes, then the particular semantic feature is skipped; if not, then it is added to the master list.

As shown in block 307, each asset i is associated with a vector Vi, of the same dimension as the list of all semantic features identified in block 305. For example, if the asset i captures semantic feature k, then the k^{th} index of Vi is set to the associated confidence score of that semantic feature when extracted from sub-asset j. If not, then the k^{th} index of Vi is assigned the value of 0.

As shown in block 309, the system then runs a clustering algorithm (such as K-means) to group the assets into clusters based on the distance between these assets in relation to the extracted semantic features. That is, assets having similar semantic features (related to a particular topic) are clustered together.

As shown in block 311, the system then takes the centroids of each cluster as the target list of assets.

As shown in block 313, the system then verifies that the target list captures all the semantic features expressed across the assets. If not, then the process is repeated focusing only on the semantic features not represented, and further clustering is based on those previously unrepresented semantic features.

The flow chart ends at terminator block 315.

While the process depicted in FIG. 3 focuses on identifying most relevant assets to capture all relevant features, the method can be extended to handle sub-assets (i.e., semantic features within the assets), where a sub-asset is a subset component of an asset, and where each sub-asset is a smaller component based on the structure of the original asset. For a document, the sub-assets can be the paragraphs. For a video, it could be a frame. For a web page, it could be an html div.

An example of the process depicted in FIG. 3 is as follows.

Suppose that there exists a large volume of video content on how to upgrade RAM on a particular computer model, which will be referred to as “Computer X”.

Given a list of 100 videos about RAM, the present invention executes steps to identify the most relevant content.

Using NLP and image recognition, the method/algorithm/system traverses the videos to gather semantic features for each video by segmenting the videos into 30 second frames.

All of the semantic features are then consolidated in a master list, where only unique features are documented, and duplicates are omitted.

For each video, the method then identifies whether or not the video contains the semantic features identified in the master list. If the video does contain the feature, then the confidence score of 1 is assigned to the video. If the video does not contain the feature, a 0 is assigned. This identifies those video frames that have the most relevant content on the topic (i.e. upgrading RAM in Computer X).

Next the clustering algorithm is executed to identify all like video frames by semantic feature. This allows the various frames to be grouped so that those with the same features are not duplicated in results. Each of the groups are evaluated to find the centroids, or just those frames that embody the distinct semantic features. In the example described above, in which the user wants information about upgrading the RAM in Computer X, the various video frames will include content on selecting the correct type of RAM, how to open up Computer X to access the RAM, how to install the RAM, and lastly how to validate the RAM was installed correctly.

In an embodiment of the present invention, all of the semantic features are present across the resulting list of videos identified as the final output of the method.

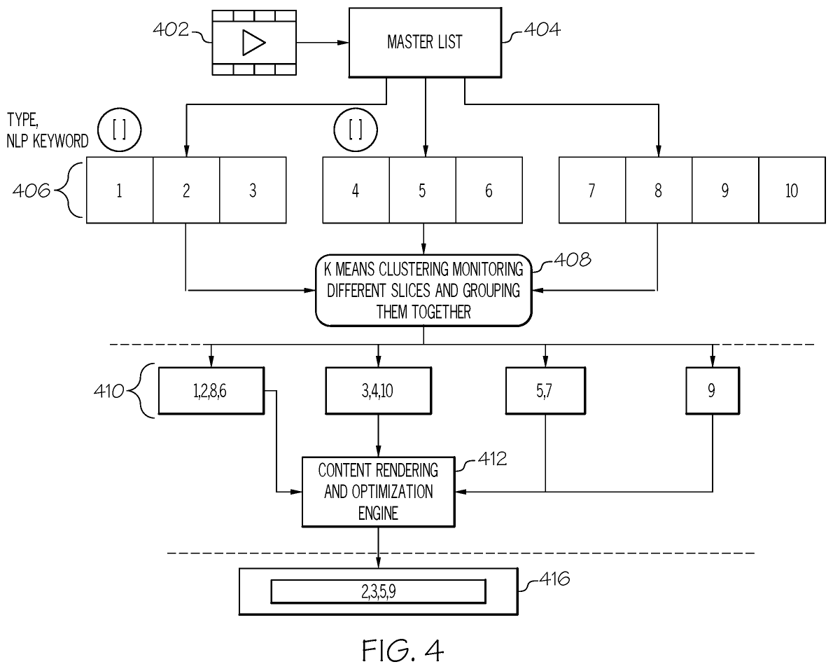

With reference now to FIG. 4, additional detail of one or more embodiments of the present invention is presented.

The goal of the process shown in FIG. 4 is to create optimal content 416 (analogous to optimal content 216 shown in FIG. 2), which is content that addresses the informational needs of an end user.

As shown in FIG. 4, assets 402 (analogous to asset 202 and asset 208 shown in FIG. 2) are assigned to a master list 404, using the process described above.

Using natural language processing (NLP) to identify keywords, key images, etc. for a particular topic/semantic feature, sets of semantic features 406 are extracted from the assets. For example, a first asset has the semantic features labeled as “1, 2, 3”; a second asset has the semantic features labeled as “4, 5, 6”; and a third asset has the semantic features labeled as “7, 8, 9, 10”.

The process shown in block 408 uses clustering monitoring (e.g., K means clustering monitoring) of different slices (e.g., 1, 2, 8, 6; 3, 4, 10; 5, 7; 9) from the semantic features 406, and groups them together according to their vector distances from one another (as described above).

In order to create the final optimal content 416, a content rendering and optimization engine 412 takes the grouped slices 410, which are the clusters passages, video clips, etc. taken from a set of assets 402 using the process shown in block 408, and combines them (e.g., semantic assets 2, 3, 5, 9) to form the final optimal content 416.

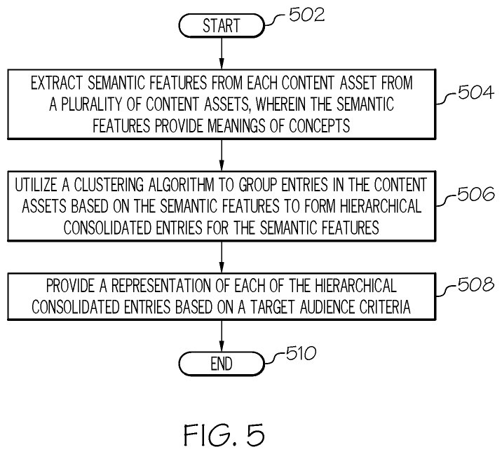

With reference now to FIG. 5, a high-level flow chart of one or more operations performed by one or more embodiments of the present invention is presented.

After initiator block 502, one or more processors (e.g., processor 104 shown in FIG. 1) extracts semantic features from each content asset from a plurality of content assets, where the semantic features provide meanings of concepts, as shown in block 504.

As described in block 506, the processor(s) utilize a clustering algorithm to group entries in the content assets based on the semantic features to form hierarchical consolidated entries for the semantic features, where each hierarchical consolidated entry is associated with one of the semantic features.

For example, consider the semantic features shown in one of the group slices from group slices 410 in FIG. 4 as “1, 2, 8, 6”. Assume further that the semantic features labeled as “1, 2, 8, 6” are for the following semantic features: 1—Computer X; 2—components; 8—RAM; 6—dual in-line memory module (DIMM). As such, the DIMM (feature 6) hierarchically depends on the semantic feature of RAM (feature 8), which hierarchically depends on the semantic feature of components (feature 2), which hierarchically depends on the semantic feature of Computer X (feature 1). Thus, each grouping of semantic features shown in group slices 410 in FIG. 4 are hierarchically related.

As shown in block 508, the processor(s) then provide a representation of each of the hierarchical consolidated entries based on a target audience criteria. That is, if the target audience criteria is for a user who wants to add new DIMM RAM to Computer X, then the hierarchical consolidated entries just described will be presented to that user.

The flow chart ends at terminator block 510.

In an embodiment of the present invention, the processor(s) create a confidence score for each extracted semantic feature; create a master list of extracted semantic features across the plurality of content assets; and remove from the master list any extracted semantic feature whose confidence score falls below a predetermined value. That is, when creating the master list 404 shown in FIG. 4, any semantic features that are not certain to accurately describe a certain feature needed by a particular user are removed from the master list.

In an embodiment of the present invention, this confidence score is based on a natural language processing (NLP) evaluation of the content assets, and/or is based on a user review score of the content assets, as described above.

In an embodiment of the present invention, the content assets are aggregated into different content asset clusters, and then a content asset from each of the different content asset clusters is aggregated into an aggregation of selected content assets, such that aggregation of selected content assets provides representative information that describes concepts that meet the target audience criteria.

For example, assume that asset 202 and asset 208 (content assets) are both about a first feature of a computer chip (e.g., functional abilities). As such, assume that asset 202 includes information about the number of input/output operations per second—IOPS that the computer chip can process, while asset 208 includes information about the clock speed of the computer chip. Since both sets of information are related to functional abilities of the computer chip, then they are aggregated into a same first content asset cluster.

Assume now that a pair of assets (not depicted) contain information about usage of the computer chip. That is, a third asset/content asset contains information about which entities are using the computer chip, while a fourth asset/content asset contains information about the geolocations in which the computer chips are being used. Since both sets of information are related to usage of the computer chip, they are aggregated into a same second content asset cluster.

Assume now that information that meets the target audience criteria (i.e., directions on how to replace a computer chip) includes the IOPS speed of the computer chip and the location of the computer chip. That is, assume that the target audience wants information about where a particular computer chip (operating at a particular IOPS speed) is located, such that it can be replaced with another (e.g., upgraded) computer chip. As such, the system extracts the content asset/asset 202 from the first content asset cluster, and the asset/content asset about the geolocation of the computer chip from the second content asset cluster, and aggregates these two assets/content assets into an aggregation of selected content assets, which provide the information needed by the requester (i.e., the IOPS speed of the computer chip and where it is located).

In an embodiment of the present invention, the hierarchical consolidated entries are utilized to train a machine learning system to recognize the semantic features in other content assets.

The machine learning system 124 shown in FIG. 1 that is trained to recognize the semantic features in other content assets may be a neural network such as a Deep Neural Network (DNN), a Convolutional Neural Network (CNN), or any other machine learning system. In a preferred embodiment, a DNN is used to recognize semantic features in text/numeric data, while a CNN is used to recognize semantic features depicted in an image (e.g., a digital photograph).

A neural network, as the name implies, is roughly modeled after a biological neural network (e.g., a human brain). A biological neural network is made up of a series of interconnected neurons, which affect one another. For example, a first neuron can be electrically connected by a synapse to a second neuron through the release of neurotransmitters (from the first neuron) which are received by the second neuron. These neurotransmitters can cause the second neuron to become excited or inhibited. A pattern of excited/inhibited interconnected neurons eventually lead to a biological result, including thoughts, muscle movement, memory retrieval, etc. While this description of a biological neural network is highly simplified, the high-level overview is that one or more biological neurons affect the operation of one or more other bio-electrically connected biological neurons.

An electronic neural network similarly is made up of electronic neurons. However, unlike biological neurons, electronic neurons are never technically “inhibitory”, but are only “excitatory” to varying degrees.

In a DNN, neurons are arranged in layers, known as an input layer, hidden layer(s), and an output layer. The input layer includes neurons/nodes that take input data, and send it to a series of hidden layers of neurons, in which all neurons from one layer in the hidden layers are interconnected with all neurons in a next layer in the hidden layers. The final layer in the hidden layers then outputs a computational result to the output layer, which is often a single node for holding vector information.

With reference now to FIG. 6, a Deep Neural Network (DNN) 624 used to recognize semantic features in assets in one or more embodiments of the present invention is presented. For example, content asset text data 600 is text and/or data that describes features of a particular type of computer and/or its components.

The electronic neurons in DNN 624 are arranged in layers, known as an input layer 603, hidden layers 605, and an output layer 607. The input layer 603 includes neurons/nodes that take input data, and send it to a series of hidden layers of neurons (e.g., hidden layers 605), in which neurons from one layer in the hidden layers are interconnected with all neurons in a next layer in the hidden layers 605. The final layer in the hidden layers 605 then outputs a computational result to the output layer 607, which is often a single node for holding vector information. In an embodiment of the present invention, each neuron in the output layer 607 is associated with a particular label from labels 602, as shown in FIG. 6.

As just mentioned, each node in the depicted DNN 624 represents an electronic neuron, such as the depicted neuron 609. As shown in block 611, each neuron (including neuron 609) functionally includes at least four features: an algorithm, an output value, a weight, and a bias value.

The algorithm is a mathematical function (e.g., a mathematic formula) for processing data from one or more upstream neurons. For example, assume that one or more of the neurons depicted in the middle hidden layers 605 send data values to neuron 609. Neuron 609 then processes these data values by executing the mathematical function shown in block 611, in order to create one or more output values, which are then sent to another neuron, such as another neuron within the hidden layers 605 or a neuron in the output layer 607. Each neuron also has a weight that is specific for that neuron and/or for other connected neurons. Furthermore, the output value(s) are added to bias value(s), which increase or decrease the output value, allowing the DNN 624 to be further “fine tuned”.

For example, assume that neuron 613 is sending the results of its analysis of a piece of data to neuron 609. Neuron 609 has a first weight that defines how important data coming specifically from neuron 613 is. If the data is important, then data coming from neuron 613 is weighted heavily, and/or increased by the bias value, thus causing the mathematical function (s) within neuron 609 to generate a higher output, which will have a heavier impact on neurons in the output layer 607. Similarly, if neuron 613 has been determined to be significant to the operations of neuron 609, then the weight in neuron 613 will be increased, such that neuron 609 receives a higher value for the output of the mathematical function in the neuron 613. Alternatively, the output of neuron 609 can be minimized by decreasing the weight and/or bias used to affect the output of neuron 609. These weights/biases are adjustable for one, some, or all of the neurons in the DNN 624, such that a reliable output will result from output layer 607. In one or more embodiments of the present invention, finding the values of weights and bias values is done automatically by training the neural network. In one or more embodiments of the present invention, manual adjustments are applied to tune the hyperparameters such as learning rate, dropout, regularization factor and so on. As such, training a neural network involves running forward propagation and backward propagation on multiple data sets until the optimal weights and bias values are achieved to minimize a loss function. The loss function measures the difference in the predicted values by the neural network and the actual labels for the different inputs.

When manually adjusted, the weights are adjusted by the user, sensor logic, etc. in a repeated manner until the output from output layer 607 matches expectations. For example, assume that input layer 603 receives inputs that describe a particular computer. In an exemplary input, the input to input layer 603 contains values that describe that particular computer. If DNN 624 has been properly trained (by adjusting the mathematical function (s), output value(s), weight(s), and biases in one or more of the electronic neurons within DNN 624) to output a 3-tuple output vector (e.g., 0.9, 0.4, 0.3) to the output layer 607, indicating that the neuron 604 that is associated with the label “First semantic feature” for a particular type of replacement RAM in computer X has the highest value (0.9), then it indicates that the content asset text data 600 describes that first semantic feature (e.g., a description of that particular RAM). The second semantic feature (with the value of 0.4) describes the model of that computer, while the third semantic feature (with the value of 0.3) describes a color of that computer.

When automatically adjusted, the weights (and/or mathematical function) are adjusted using “back propagation”, in which weight values of the neurons are adjusted by using a “gradient descent” method that determines which direction each weight value should be adjusted to. This gradient descent process moves the weight in each neuron in a certain direction until the output from output layer 607 improves (e.g., gets closer to outputting a highest value to neuron 604, thus indicating that the content asset text data 600 includes a description of a replacement RAM for Computer X).

In one or more embodiments of the present invention, a Convolutional Neural Network (CNN) is utilized to analyze images.

A CNN is similar to a DNN in that both utilize interconnected electronic neurons.

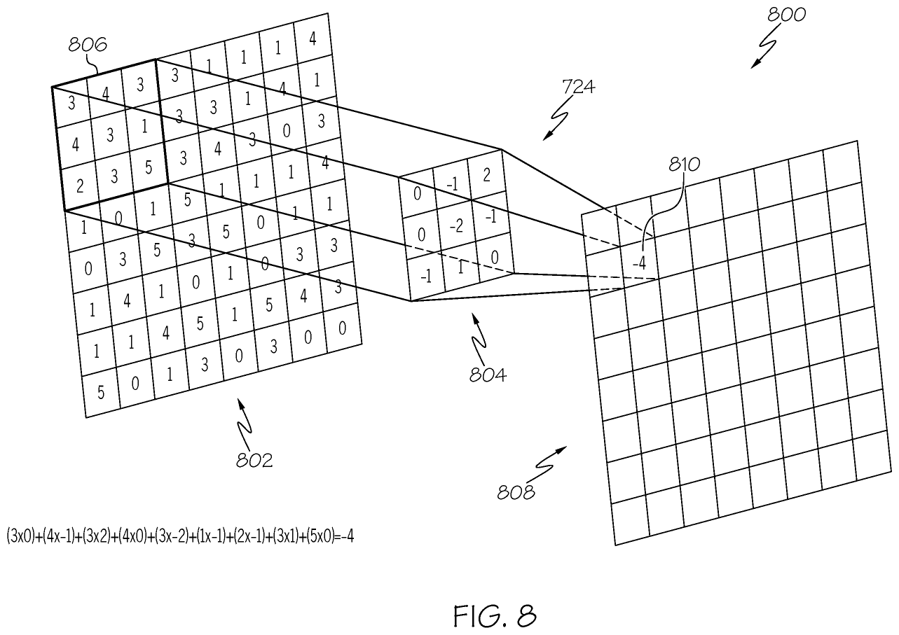

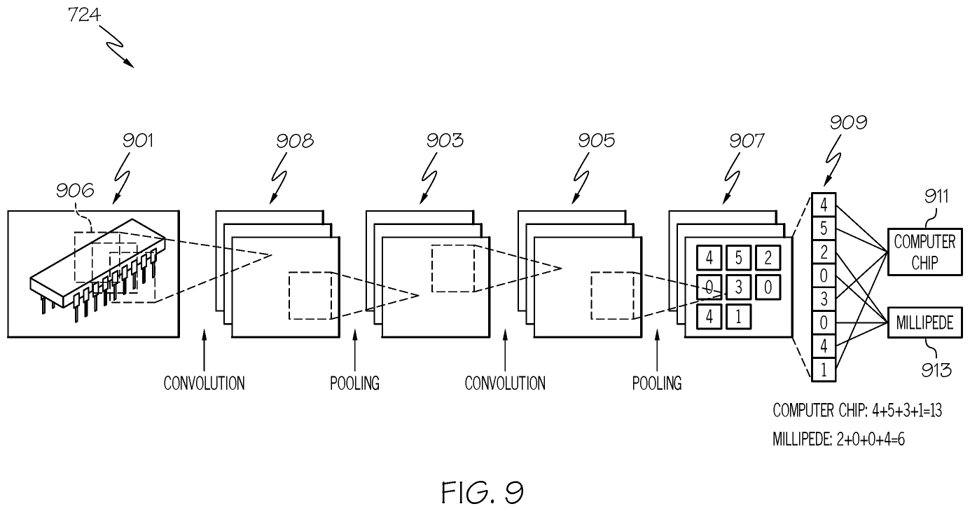

However, a CNN is different from a DNN in that 1) a CNN has neural layers whose sizes are based on filter sizes, stride values, padding values, etc. (see FIGS. 8) and 2) a CNN utilizes a convolution scheme to analyze image data (see FIG. 9). A CNN gets its “convolutional” name based on a convolution (i.e., a mathematical operation on two functions to obtain a result) of filtering and pooling pixel data (a mathematical operation on two functions) in order to generate a predicted output (obtain a result).

With reference now to FIG. 7, an exemplary CNN 724 is presented. Each depicted node in FIG. 7 represents a neuron (i.e., an electronic neuron). In accordance with one or more embodiments of the present invention, an input layer 703 includes neurons that receive data that describes pixels from a photograph, such as an image of a computer chip, shown as content asset visual image 701. The neurons from the input layer 703 of the CNN 724 connect neurons in a middle layer 705, which connect to neurons in the output layer 707.

As just mentioned, each node in the depicted CNN 724 represents an electronic neuron, such as the depicted neuron 709. As shown in block 711, each neuron (including neuron 709) functionally includes at least four features: a mathematical function, an output value, a weight, and a bias (similar to those described in neuron nodes in the DNN 624 shown in FIG. 6).

For example, assume that neuron 713 is sending the results of its analysis of content asset visual image 701 to neuron 709. Neuron 709 has a first weight that defines how important data coming specifically from neuron 713 is. If the data is important, then data coming from neuron 713 is weighted heavily, thus causing the mathematical function(s) within neuron 709 to generate a higher output, which will have a heavier impact on neurons in the output layer 707. Similarly, if neuron 713 has been determined to be significant to the operations of neuron 709, then the weight in neuron 713 will be increased, such that neuron 709 receives a higher value for the output of the algorithm in the neuron 713. These weights are adjustable for one, more, or all of the neurons in the CNN 724, such that a reliable output will result from output layer 707. In one or more embodiments of the present invention, finding the values of weights and bias values is done automatically by training the neural network. In one or more embodiments of the present invention, manual adjustments are applied to tune the hyperparameters such as learning rate, dropout, regularization factor and so on. As such, training a neural network involves running forward propagation and backward propagation on multiple data sets until the optimal weights and bias values are achieved to minimize a loss function. The loss function measures the difference in the predicted values by the neural network and the actual labels for the different inputs.

When manually adjusted, the weights are adjusted by the user, sensor logic, etc. in a repeated manner until the output from output layer 707 matches expectations. For example, assume that input layer 703 receives pixel values (color, intensity, shading, etc.) from pixels in a photograph of a computer chip (content asset visual image 701). If the output from output layer 707 includes neuron/node 704, which is associated with a label 715 (i.e., a first semantic feature, such as that of a computer chip), then the weights (and/or the mathematical function and/or biases in “upstream” nodes/neurons) are adjusted until neuron/node 704 contains the highest value in the output layer 707 when pixel data from a photograph of a computer chip is input into input layer 703.

When automatically adjusted, the weights (and/or mathematical functions and/or biases) are adjusted using “back propagation”, in which weight values and/or biases and/or mathematical functions of the neurons are adjusted by using a “gradient descent” method that determines which direction each weight value should be adjusted to. This gradient descent process moves the weight in each neuron in a certain direction until the output from output layer 707 improves (e.g., neuron 704 has the higher value than node 706 that is associated with the label 717 for a second semantic feature (i.e., that of a millipede). Thus, since the CNN 724 recognizes the content asset visual image 701 as depicting a computer chip (e.g., a replacement RAM) instead of a millipede, then it is properly trained.

A CNN process includes 1) a convolution stage (depicted in FIG. 8), followed by a 2) pooling stage and a classification stage (depicted in FIG. 9).

With reference now to FIG. 8, a convolution/pooling scheme to analyze image data is presented in CNN convolution process 800. As shown in FIG. 8, pixel data from a photographic image (e.g., content asset visual image 701 shown in FIG. 7) populates an input table 802. Each cell in the input table 802 represents a value of a pixel in the photograph. This value is based on the color and intensity for each pixel. A subset of pixels from the input table 802 is associated with a filter 804. That is, filter 804 is matched to a same-sized subset of pixels (e.g., pixel subset 806) by sliding the filter 804 across the input table 802. The filter 804 slides across the input grid at some predefined stride (i.e., one or more pixels). Thus, if the stride is “1”, then the filter 804 slides over in increments of one (column) of pixels. In the example shown in FIG. 8, this results in the filter 804 sliding over the subset of pixels shown as pixel subset 806 (3,4,3,4,3,1,2,3,5 when read from left to right for each row) followed by filter 804 sliding over the subset of pixels just to the right (4,3,3,3,1,3,2,5,3). If the stride were “2”, then the next subset of pixels that filter 804 would slide to would be (3,3,1,1,3,3,5,3,4).

Filter 804 is applied against each pixel subset using a mathematical formula. That is, the values in the filter 804 are added to, subtracted from, multiplied by, divided by, or otherwise used in a mathematical operation and/or algorithm with the values in each subset of pixels. For example, assume that the values in filter 804 are multiplied against the pixel values shown in pixel subset 806 ((3×0)+(4×−1)+(3×2)+(4×0)+(3×−2)+(1×−1)+(2×−1)+(3×1)+(5×0)) to arrive at the value of −4. This value is then used to populate feature map 808 with the value of −4 in cell 810.

In a preferred embodiment, the convolution step also includes use of an activation function, which transforms the output of the convolution operation into another value. One purpose of the use of an activation function is to create nonlinearity in the CNN. A choice of specific activation function depends on an embodiment. Popular choices of an activation function include a rectified linear unit (ReLU), a leaky ReLU, a sigmoid function, a tanh function, and so on.

In an embodiment, each subset of pixels uses a same filter. However, in a preferred embodiment, the filter used by each subset of pixels is different, thus allowing a finer level of granularity in creating the feature map.

With reference now to FIG. 9, the pooling stage and a classification stage (as well as the convolution stage) of a CNN 724 during inference processing is depicted. That is, once the CNN 724 is optimized by adjusting weights and/or mathematical functions and/or biases in the neurons (see FIG. 7), by adjusting the stride of movement of the pixel subset 806 (see FIG. 8), and/or by adjusting the filter 804 shown in FIG. 8, then it is trusted to be able to recognize similar objects in similar photographs. This optimized CNN is then used to infer (hence the name inference processing) that the object in a new photograph is the same object that the CNN has been trained to recognize.

As shown in FIG. 9, assume that pixels from a photograph (computer chip image 901, which is analogous to content asset visual image 701) are used as inputs to the input table 802 shown in FIG. 8, using a CNN that has been previously defined and optimized to recognize the image of a computer chip. Assume further that a series of pixel subsets, including the pixel subset 906 (analogous to pixel subset 806 shown in FIG. 8) are convolved (using the process described in FIG. 8), thus resulting in a set of feature maps 908 (analogous to feature map 808 shown in FIG. 8). Once the feature maps 908 are generated, they are pooled into smaller pooled tables 903, in order to reduce the dimensionality of the values, thereby reducing the number of parameters and computations required in the CNN process. Once these pooled tables 903 are created, they themselves are then convoluted to create new (and even more compressed) feature maps 905, which are then pooled to create even more compressed pooled tables 907.

The pooled tables 907 (which in an embodiment is actually a single table) are “unrolled” to form a linear vector, shown in FIG. 9 as a fully connected layer 909. Fully connected layer 909 is connected to a prediction output, including prediction output 911 (for a computer chip) and prediction output 913 (for a millipede).

For example, assume that for a prediction output to be considered accurate, it must have an arbitrarily chosen total value of 10 or greater for the sum of values from cells in the fully connected layer 909 to which it is connected. As such, the prediction output 911 is connected to cells in the fully connected layer 909 that have the values of 4, 5, 3, and 1, resulting in a sum total of 13. Thus, the CNN 724 concludes that computer chip image 901 is in fact that of a computer chip, such as a processor chip, and not a photo of a millipede.

In one or more embodiments, an output function, such as a softmax function, amplifies larger output values, attenuates smaller output values, and normalizes all output values in order to ensure that their total sum is one. That is, rather than assigning an arbitrary number (e.g., 10) as being what the sum total of values in certain cells from the connected layer 909 must exceed in order to indicate that a particular entity (e.g., a computer chip) is portrayed in the new photograph, an output function such as a softmax function dynamically adjusts the output values and then normalizes them, such that they sum up to 1.0 or some other predetermined number. Thus, while the described values shown in FIG. 9 describe the concept of output values describing entities in the photographs, in practice a static threshold value is not used in certain embodiments. Rather, in this alternative/preferred embodiment, the system utilizes a normalized summation (as just described), in order to further control the output characteristics, thus more accurately determining the label of the object in the photograph.

The prediction output 913 for a millipede is only 6 (2+0+0+4) based on the cells in the fully connected layer 909 to which it is attached. That is, the CNN 724 presents “millipede” as a second guess as to what is depicted by the computer chip image 901. However, since the confidence level of this guess is so low (“6” in this example), then the system will go with the prediction that the computer chip image 901 is in fact that of a computer chip, and not a millipede.

As discussed above with regard to FIG. 9, inference is the process of using a trained CNN to recognize certain objects from a photograph or other data. In the example in FIG. 9, pixels from computer chip image 901 are input into a trained CNN (e.g., CNN 724), resulting in the identification and/or labeling (for display on the photograph/computer chip image 901) a particular object, such as the computer chip shown in FIG. 9.

That is, a CNN is trained to recognize a certain object (e.g., a computer chip in a photograph). By using a new photograph as an input to the trained CNN, a computer chip shown in another photograph is also identified/labeled using a process known as inferencing. This inferencing occurs in real time, and recognizes specific objects (e.g., a computer chip) by running the new photograph through the trained CNN.

In an embodiment of the present invention, one of the hierarchical consolidated entries describes a process for improving a functionality of a device, and the method further comprises performing the process for improving the functionality of the device. For example, assume that the end user 218 shown in FIG. 2 wants to upgrade the RAM in Computer X, as described above. The optimal content 216 is made up of the hierarchical consolidated entries described above, thus allowing the end user 218 to upgrade the Computer X. In an embodiment of the present invention, end user 218 is not a person, but rather is a robotic device, which installs the new RAM into Computer X, such that no human intervention is required. That is, the robot device (end user 218) receives the hierarchical consolidated entries (optimal content 216), and autonomously installs the new RAM into computer X (computer 220 shown in FIG. 2).

In one or more embodiments, the present invention is implemented using cloud computing. Nonetheless, it is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model includes at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but still is able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. In one or more embodiments, it is managed by the organization or a third party and/or exists on-premises or off-premises.

Community cloud: the cloud infrastructure is shared by several organizations and supports a specific community that has shared concerns (e.g., mission, security requirements, policy, and compliance considerations). In one or more embodiments, it is managed by the organizations or a third party and/or exists on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

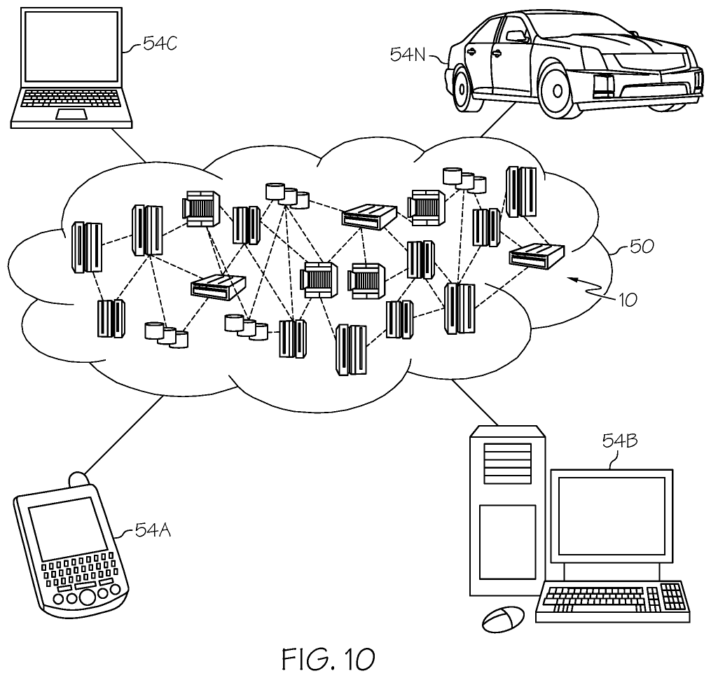

Referring now to FIG. 10, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N communicate with one another. Furthermore, nodes 10 communicate with one another. In one embodiment, these nodes are grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-54N shown in FIG. 10 are intended to be illustrative only and that computing nodes 10 and cloud computing environment 50 can communicate with any type of computerized device over any type of network and/or network addressable connection (e.g., using a web browser).

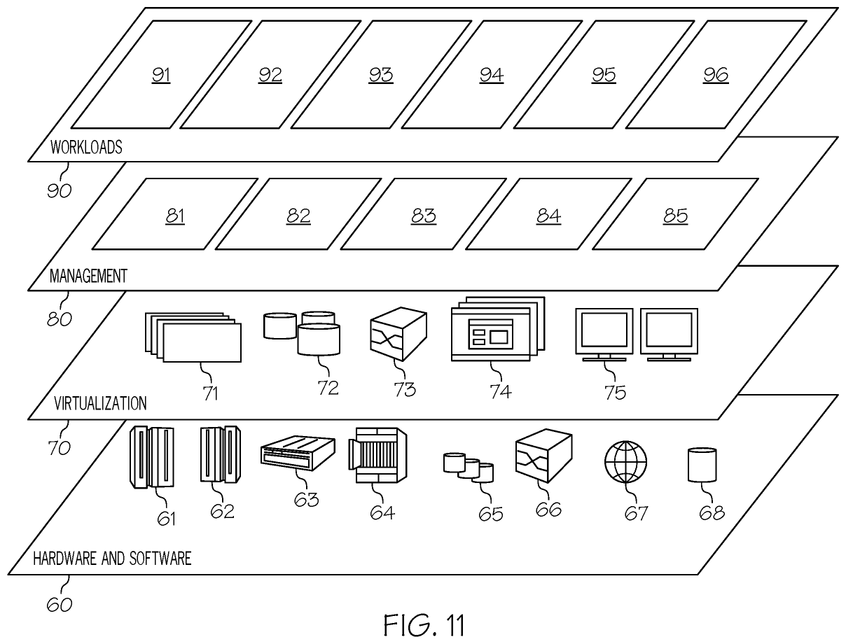

Referring now to FIG. 11, a set of functional abstraction layers provided by cloud computing environment 50 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities that are provided in one or more embodiments: virtual servers 71; virtual storage 72; virtual networks 73, including virtual private networks; virtual applications and operating systems 74; and virtual clients 75.

In one example, management layer 80 provides the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment are utilized in one or more embodiments. Examples of workloads and functions which are provided from this layer include: mapping and navigation 91; software development and lifecycle management 92; virtual classroom education delivery 93; data analytics processing 94; transaction processing 95; and asset management and machine learning processing 96, which performs one or more of the features of the present invention described herein.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

In one or more embodiments of the present invention, any methods described in the present disclosure are implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, in one or more embodiments of the present invention any software-implemented method described herein is emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method comprising:
extracting, by one or more processors, semantic features from each content asset from a plurality of content assets, wherein the semantic features provide meanings of concepts;
utilizing, by one or more processors, a clustering algorithm to group entries in the content assets based on the semantic features to form hierarchical consolidated entries for the semantic features, wherein each hierarchical consolidated entry is associated with one of the semantic features; and
providing, by one or more processors, a representation of each of the hierarchical consolidated entries based on a target audience criteria.

2. The method of claim 1, further comprising:
creating, by one or more processors, a confidence score for each extracted semantic feature;
creating, by one or more processors, a master list of extracted semantic features across the plurality of content assets; and
removing from the master list, by one or more processors, any extracted semantic feature whose confidence score falls below a predetermined value.

3. The method of claim 2, wherein the confidence score is based on a natural language processing (NLP) evaluation of the content assets.

4. The method of claim 2, wherein the confidence score is based on a user review score of the content assets.

5. The method of claim 1, further comprising:
utilizing the hierarchical consolidated entries to train a machine learning system to recognize the semantic features in other content assets.

6. The method of claim 1, wherein one of the hierarchical consolidated entries describes a process for improving a functionality of a device, and wherein the method further comprises:
performing the process for improving the functionality of the device.

7. The method of claim 1, further comprising:
aggregating, by one or more processors, the content assets into different content asset clusters; and
aggregating, by one or more processors, a content asset from each of the different content asset clusters into an aggregation of selected content assets, wherein the aggregation of selected content assets provides representative information that describes concepts that meet the target audience criteria.

8. A computer program product comprising a computer readable storage medium having program code embodied therewith, wherein the computer readable storage medium is not a transitory signal per se, and wherein the program code is readable and executable by a processor to perform a method comprising:
extracting semantic features from each content asset from a plurality of content assets, wherein the semantic features provide meanings of concepts;
utilizing a clustering algorithm to group entries in the content assets based on the semantic features to form hierarchical consolidated entries for the semantic features, wherein each hierarchical consolidated entry is associated with one of the semantic features; and
providing a representation of each of the hierarchical consolidated entries based on a target audience criteria.

9. The computer program product of claim 8, wherein the method further comprises:
creating a confidence score for each extracted semantic feature;
creating a master list of extracted semantic features across the plurality of content assets; and
removing from the master list any extracted semantic feature whose confidence score falls below a predetermined value.

10. The computer program product of claim 9, wherein the confidence score is based on a natural language processing (NLP) evaluation of the content assets.

11. The computer program product of claim 9, wherein the confidence score is based on a user review score of the content assets.

12. The computer program product of claim 8, wherein the method further comprises:
utilizing the hierarchical consolidated entries to train a machine learning system to recognize the semantic features in other content assets.

13. The computer program product of claim 8, wherein one of the hierarchical consolidated entries describes a process for improving a functionality of a device, and wherein the method further comprises:
performing the process for improving the functionality of the device.

14. The computer program product of claim 8, wherein the method further comprises:
aggregating the content assets into different content asset clusters; and
aggregating a content asset from each of the different content asset clusters into an aggregation of selected content assets, wherein the aggregation of selected content assets provides representative information that describes concepts that meet the target audience criteria.

15. The computer program product of claim 8, wherein the program code is provided as a service in a cloud environment.

16. A computer system comprising one or more processors, one or more computer readable memories, and one or more computer readable non-transitory storage mediums, and program instructions stored on at least one of the one or more computer readable non-transitory storage mediums for execution by at least one of the one or more processors via at least one of the one or more computer readable memories, the stored program instructions executed to perform a method comprising:
extracting semantic features from each content asset from a plurality of content assets, wherein the semantic features provide meanings of concepts;
utilizing a clustering algorithm to group entries in the content assets based on the semantic features to form hierarchical consolidated entries for the semantic features, wherein each hierarchical consolidated entry is associated with one of the semantic features; and
providing a representation of each of the hierarchical consolidated entries based on a target audience criteria.

17. The computer system of claim 16, wherein the method further comprises:
creating a confidence score for each extracted semantic feature;
creating a master list of extracted semantic features across the plurality of content assets; and
removing from the master list any extracted semantic feature whose confidence score falls below a predetermined value.

18. The computer system of claim 17, wherein the confidence score is based on a natural language processing (NLP) evaluation of the content assets.

19. The computer system of claim 16, wherein the method further comprises:
aggregating the content assets into different content asset clusters; and
aggregating a content asset from each of the different content asset clusters into an aggregation of selected content assets, wherein the aggregation of selected content assets provides representative information that describes concepts that meet the target audience criteria.

20. The computer system of claim 16, wherein the stored program instructions are provided as a service in a cloud environment.
